(19) United States
(12) Patent Application Publication
(10) Pub. No.: US 2010/0014778 A1
(43) Pub. Date: Jan. 21, 2010

(54) IMAGE CORRECTING APPARATUS, IMAGE CORRECTING METHOD, PROJECTOR AND PROJECTION SYSTEM

(75) Inventor: Shun IMAI, Matsumoto-shi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/483,783

(22) Filed: Jun. 12, 2009

(30) Foreign Application Priority Data
Jul. 18, 2008 (JP) 2008-186836

(51) Int. Cl. G06K 9/40

(52) U.S. Cl. 382/275

(57) ABSTRACT

An image correcting apparatus that corrects an image to be projected by a projector on the basis of a local distortion of the projection plane includes an amount-of-distortion calculating unit that calculates the amount of distortion at each of a plurality of feature points on an image, which is projected on the projection plane, for calculating the amount of distortion on the basis of the captured image obtained by capturing the image, an image-correcting-method selecting unit that selects an image correcting method according to the amount of distortion at each of the feature points, which is calculated by the amount-of-distortion calculating unit, and an image correction processing unit that corrects a predetermined area of the image to be projected by the image correcting method selected by the image-correcting-method selecting unit.

### BACKGROUND

1. Technical Field

The present invention relates to an image correcting apparatus, image correcting method, projector and projection system that correct a projected image on a projection plane.

2. Related Art

In recent years, close projection systems have been developed each of which has a projector at a position close to a screen and performs projection from the projector to the screen.

FIGS. 10A and 10B are diagrams illustrating an example of the close projection systems. In the close projection system, a projector PJ may often be disposed at a position immediately before a screen SCR and close to the lower end of the screen SCR, as shown in FIG. 10A.

In the close projection system, the projected light from the projector PJ is launched to the screen SCR at an acute angle. Therefore, when the screen SCR has a local distortion, the projected image at the local distortion part on the screen SCR has a distortion. For example, as shown in FIG. 10B, when the screen SCR has a local distortion of a concave/convex (which is a convex h in FIG. 10B), the convex h has a distorted projected image. In other words, the image by the pixels to be projected at the position P1 in FIG. 10B is actually projected at the position P1′ on the convex h of the screen SCR. Therefore, when the direction of line of sight of audiences is perpendicular to the screen SCR, the projected image has a distortion on the convex h of the screen SCR. Notably, while FIGS. 10A and 10B show the case where the screen SCR has the convex h, a distortion may also occur when the screen SCR has a concave.

The distortion of a projected image due to a local distortion of a screen may also cause the reduction of image quality. Particularly, in a projection system in which projected light launches from the projector PJ to the screen SCR at an acute angle, like close projection systems as shown in FIGS. 10A and 10B, the distortion of the projected image due to a local distortion of the screen is clearly recognized by audiences.

Various technologies have been proposed which perform image correction such that, in a projection system in which the projected light from the projector PJ launches into the screen SCR at an acute angle, the image projected from the projector PJ to the screen SCR can be displayed correctly when viewed from the direction of line of sight of the audiences (refer to JP-A-2001-83949, for example).

The technology (which will be called related art) disclosed in JP-A-2001-83949 is an image display apparatus having a projector disposed such that the projected light can launch into a screen at an acute angle. In the image display apparatus, an image for calculating an amount of distortion as a test image is projected to the screen by the projector, and the projected image for calculating the amount of distortion is captured by an capturing apparatus 200 (refer to FIGS. 10A and 10B). On the basis of the thus obtained, captured image data, correction data for giving the opposite distortion is created so that the correction data can be used for the image correction.

The screen SCR may often have plural local distortions (or concaves/convexes) as shown in FIG. 10B. If the screen SCR has plural local distortions, the amounts of distortions appearing on the projected image may depend on the sizes of the distortions (each of which will be called amount of distortion) at the corresponding positions. In other words, at a position where the amount of distortion of a local distortion is large on a screen, the amount of the distortion of the projected image is large. At a position where the amount of distortion of a local distortion of the screen is not large, the amount of the distortion of the projected image is not so large either. Therefore, the distortion correction is preferably performed in accordance with the amount of distortion of a local distortion of the screen in order to obtain aesthetically even sharpness on the entire projected image.

However, according to the related art, the same correction method is applied for correction on the entire projected image. Therefore, when a screen has plural local distortions, the corrected projected image does not have aesthetically even sharpness as a whole, which is a problem.

FIGS. 11A and 11B are diagrams illustrating the relationship between the captured image obtained by capturing an image for calculating the amount of distortion with a capturing apparatus and the sharpness. FIG. 11A shows a captured image obtained by capturing an image for calculating the amount of distortion with a capturing apparatus, and FIG. 11B shows MTFs (Modulation Transfer Functions) of an image for calculating the amount of distortion at corresponding positions. Notably, the MTF is an indicator that indicates the sharpness of an image, and, as the MTF increases, the sharpness of the image increases.

FIG. 11A shows white circles representing feature points P11, P12, . . . , P21, P22, . . . , and an image for calculating the amount of distortion has the feature points P11, P12, . . . and P21, P22, . . . arranged in a longitudinal direction and lateral direction at equal intervals.

Therefore, when a screen has no local distortion, the captured image obtained by capturing an image for calculating the amount of distortion has the feature points P11, P12, . . . , and P21, P22, . . . in a longitudinal direction and a lateral direction at equal intervals. On the other hand, when a screen has a local distortion, the feature points (such as the feature points P22 and P24) at the positions corresponding to the local distortion of the screen have an image displaced from the original positions, as indicated by the broken circles A1 and A2 in FIG. 11A, on the captured image. Notably, as the amount of distortion of the local distortion of a screen increases, the amount of displacement of the position increases. Therefore, in the case in FIG. 11A, the feature points P22 and P24 have lower MTFs (or lower sharpness), and the feature point P22 particularly has a much lower NTF.

As shown in FIG. 11B, if the amounts of distortion of the local distortions of the screen differ among local distortions, the projected sharpnesses of the image differ in accordance with the amounts of distortion of the local distortions on the screen. Therefore, the sharpnesses of the entire projected image vary. As a result, like in the related art, the application of one same image correcting method for the correction on the entire projected image may not result in the projected image having aesthetically even sharpness as a whole.

### SUMMARY

It is an advantage of some aspects of the invention to provide an image correcting apparatus, image correcting method, projector and projection system that allows distortion correction for providing an aesthetically even sharpness on an entire projected image if local distortions of a screen have different amounts of distortion.

According to an aspect of the invention, there is provided an image correcting apparatus that corrects an image to be projected by a projector on the basis of a local distortion of the projection plane, the apparatus including an amount-of-distortion calculating unit that calculates the amount of distortion at each of a plurality of feature points on an image, which is projected on the projection plane, for calculating the amount of distortion on the basis of the captured image obtained by capturing the image, an image-correcting-method selecting unit that selects an image correcting method according to the amount of distortion at each of the feature points, which is calculated by the amount-of-distortion calculating unit, and an image correction processing unit that corrects a predetermined area of the image to be projected by the image correcting method selected by the image-correcting-method selecting unit.

In the image correcting apparatus of the aspect of the invention, in order to correct the local distortion of a projected image caused by the local distortion of a projection plane (screen), the amount of distortion at each of feature points on an image for calculating the amount of distortion is calculated on the basis of the captured image obtained by projecting the image for calculating the amount of distortion to the projection plane and capturing the projected image for calculating the amount of distortion. Then, the image correcting method according to the calculated amount of distortion at the feature point is selected, and the selected image correcting method is used to perform image correction locally on the projected image. Thus, the image correction can be performed in accordance with the amount of distortion at each feature point, that is, the amount of distortion of the local distortion of the projection plane. Therefore, when there are plural local distortions of the projection plane, the corrected projected image can be an image having aesthetically even sharpness as a whole. Notably, the local distortion of the projection plane may be a concave/convex, for example, locally present on the projection plane due to a “wrinkle” on the projection plane.

In the image correcting apparatus of the aspect of the invention, the feature points are preferably defined in connection with a plurality of pixels at discrete positions among the pixels in a light modulator in the projector.

By projecting the image for calculating the amount of distortion having the feature points to the projection plane and capturing the projected image for calculating the amount of distortion, an captured image can be obtained which has a local distortion of the projection plane appearing as the distortion at feature points. Thus, the captured image can be used to calculate the amount of distortion properly reflecting the local distortion of the projection plane. Notably, the feature points may be marks such as small circles and squares arranged in the longitudinal direction and lateral direction at equal intervals or intersections (grid points) of lines rendered in the longitudinal direction and lateral direction in a grid pattern.

In the image correcting apparatus of the aspect of the invention, the amount-of-distortion calculating unit preferably calculates each of the amounts of distortion at the feature points on the basis of the coordinates of the feature point on the image for calculating the amount of distortion and the coordinates of the feature point on the captured image obtained by capturing the image for calculating the amount of distortion.

Thus, even when the local distortions of the projection plane exist at plural positions on the projection plane, the amounts of distortion at the plural positions can be calculated with high accuracy.

In the image correcting apparatus of the aspect of the invention, the image-correcting-method selecting unit preferably has a function that determines the size of the amount of distortion at each of the feature points and a function that selects the image correcting method corresponding to the amount of distortion at the corresponding feature point from a plurality of kinds of image correcting methods having different accuracies of correction defined for the size of the amount of distortion.

This can allow image correction according to the amounts of distortion of the local distortion of the projection plane. More specifically, one or more threshold values are defined for determining the size of amount of distortion at each feature point, and the size of the amount of distortion at each of the feature points is determined on the basis of the two or more sizes. Then, the image correcting methods having different accuracies of correction are predefined for the sizes, and which size the amount of distortion at each feature point calculated by the amount-of-distortion calculating unit belongs to is determined. Then, an appropriate image correcting method based on the determination result is selected, and the selected image correcting method is used to perform the image correction thereon. Notably, the image correcting methods are defined for the sizes such that, as the amount of distortion at a feature point increases, the accuracy of the image correction can increase.

Because, in this way, the size of amount of distortion at each feature point is determined as one of the plural sizes of amount of distortion, and the image correction method suitable for the determined amount of distortion is selected to perform the image correction, appropriate image correction can be performed in accordance with the size of amount of distortion at each feature point.

Preferably, in the image correcting apparatus of the aspect of the invention, the plurality of sizes are two sizes of amounts of distortion at the feature points including a size equal to or larger than a predetermined value and a size smaller than the predetermined value, the plurality of kinds of image correcting method having different accuracies of correction are two kinds of image correcting methods of a first image correcting method that allows highly accurate correction and a second image correcting method that performs correction with a lower accuracy than that of the first image correcting method, if it is determined that the amount of distortion at one feature point among the feature points is equal to or higher than the predetermined value, the first image correcting method may be selected for the feature point, and if it is determined that the amount of distortion at one feature point among the feature points is lower than the predetermined value, the second image correcting method may be selected for the feature point.

In this case, whether the size of amount of distortion at a feature point is equal to or higher than a predetermined value or below the predetermined value is determined, and, on the basis of the determination result, one of the first image correcting method and the second image correcting method is selected. The selected image correcting method is applied to perform the image correction thereon. This allows the image correction according to the amount of distortion of a local distortion of the projection plane with a small amount of operations.

In the image correcting apparatus of the aspect of the invention, the first image correcting method is preferably an image correcting method by bicubic interpolation, and the second image correcting method is preferably an image correcting method by bilinear interpolation.

In this way, by selecting the image correcting method by bicubic interpolation or the image correcting method by bilinear interpolation properly in accordance with the size of the amount of distortion, the image correction can be performed with the accuracy according to the amount of distortion. Thus, the corrected projected image can have aesthetically even sharpness as a whole.

In the image correcting apparatus of the aspect of the invention, a predetermined area, which is to be corrected by the image correction processing, of the image to be projected is preferably a local area including the pixel, which corresponds to the feature point, of the image to be projected.

Defining the correction range for the image to be projected in this way to perform the image correction allows correction of a distortion of the projected image caused by a local distortion of the projection plane in the proper range.

Preferably, in the image correcting apparatus of the aspect of the invention, the projector is disposed at a position close to the projection plane and is disposed such that the projected light can launch into the projection plane at an acute angle.

The projector at a close position to the projection plane and the projection of light to the projection plane at an acute angle cause the audiences to easily visually recognize the distortion of the projected image caused by a local distortion of the projection plane where the direction perpendicular to the projection plane is the direction of line of sight. Therefore, if the direction perpendicular to the projection plane is the direction of line of sight, it is important that the entire projected image undergoes image correction for aesthetically even sharpness. Therefore, the invention may be extremely effective for performing such image correction.

According to another aspect of the invention, there is provided an image correcting method that corrects an image to be projected by a projector on the basis of a local distortion of the projection plane, the method including calculating an amount of distortion at a feature point among a plurality of feature points on the basis of the captured image obtained by capturing an image for calculating the amount of distortion, the image being projected on the projection plane and having the plurality of feature point, selecting an image correcting method according to the calculated amount of distortion at the feature point, and correcting a predetermined area of the image to be projected by the selected image correcting method.

Performing the processing can result in the image correction according to the amount of distortion of a local distortion of the projection plane. The thus corrected projected image can have aesthetically even sharpness as a whole. Preferably, the image correcting method according to the aspect of the invention also has the characteristics that the image correcting apparatus according to the above aspect of the invention has.

According to another aspect of the invention, there is provided a projector including an image correcting apparatus that corrects an image to be projected on the basis of a local distortion of the projection plane, the image correcting apparatus having an amount-of-distortion calculating unit that calculates the amount of distortion at each of a plurality of feature points on an image, which is projected on the projection plane, for calculating the amount of distortion on the basis of the captured image obtained by capturing the image, an image-correcting-method selecting unit that selects an image correcting method according to the amounts of distortion at the feature points, which are calculated by the amount-of-distortion calculating unit, and an image correction processing unit that corrects a predetermined area of the image to be projected by the image correcting method selected by the image-correcting-method selecting unit.

The projector including such image correcting apparatus can provide the same effects as the effects of the image correcting apparatus according to the above aspect of the invention. Preferably, the projector according to the aspect of the invention also has the characteristics that the image correcting apparatus according to the above aspect of the invention has.

According to another aspect of the invention, there is provided a projection system including a projector that projects an image to a projection plane and an image correcting apparatus that corrects the image to be projected by the projector on the basis of a local distortion of the projection plane, the image correcting apparatus having an amount-of-distortion calculating unit that calculates the amount of distortion at each of a plurality of feature points on an image, which is projected on the projection plane, for calculating the amount of distortion on the basis of the captured image obtained by capturing the image, an image-correcting-method selecting unit that selects an image correcting method according to the amounts of distortion at the feature points, which are calculated by the amount-of-distortion calculating unit, and an image correction processing unit that corrects a predetermined area of the image to be projected by the image correcting method selected by the image-correcting-method selecting unit.

This is a case where the image correcting apparatus is a separate component from the projector, an example of which is a case where the functions that the image correcting apparatus has are built in an information processing apparatus such as a personal computer. In this way, even when the projection system is configured by the projector and the image correcting apparatus, the same effects as those of the image correcting apparatus according to the above aspect of the invention can be obtained. Preferably, the projection system according to the aspect of the invention preferably also has the characteristics that the image correcting apparatus according to the above aspect of the invention has.

### BRIEF DESCRIPTION OF THE DRAWINGS

The invention will be described with reference to the accompanying drawings, wherein like numbers reference like elements.

FIG. 1 is a diagram showing the configuration of a projector according to the first embodiment. FIG. 2 is a diagram showing a configuration of the image correcting apparatus 330 shown in FIG. 1.

FIGS. 3A and 3B are diagrams showing examples of an image for calculating the amount of distortion to be projected to a screen and the captured image obtained by capturing the image for calculating the amount of distortion.

FIG. 4 is a flowchart illustrating the entire processing routine to be performed by the image correcting apparatus 330.

FIG. 5 is a flowchart illustrating a processing routine for calculating the amount of distortion at each feature point.

FIG. 6 is a flowchart illustrating processing for calculating the capturing apparatus coordinates of each feature point in step S11 in FIG. 5.

FIG. 7 is a diagram illustrating a definition example of the local range to be corrected.

FIG. 8 is a diagram illustrating an example of the image correction by the selected image correcting method.

FIG. 9 is a diagram showing the configuration of a projection system according to the second embodiment.

FIGS. 10A and 10B are diagrams illustrating an example of the close projection system.

FIGS. 11A and 11B are diagrams illustrating the relationship between an captured image obtained by capturing the image for calculating the amount of distortion with an capturing apparatus and the sharpness.

### DESCRIPTION OF EXEMPLARY EMBODIMENTS

An embodiment of the invention will be described below.

### First Embodiment

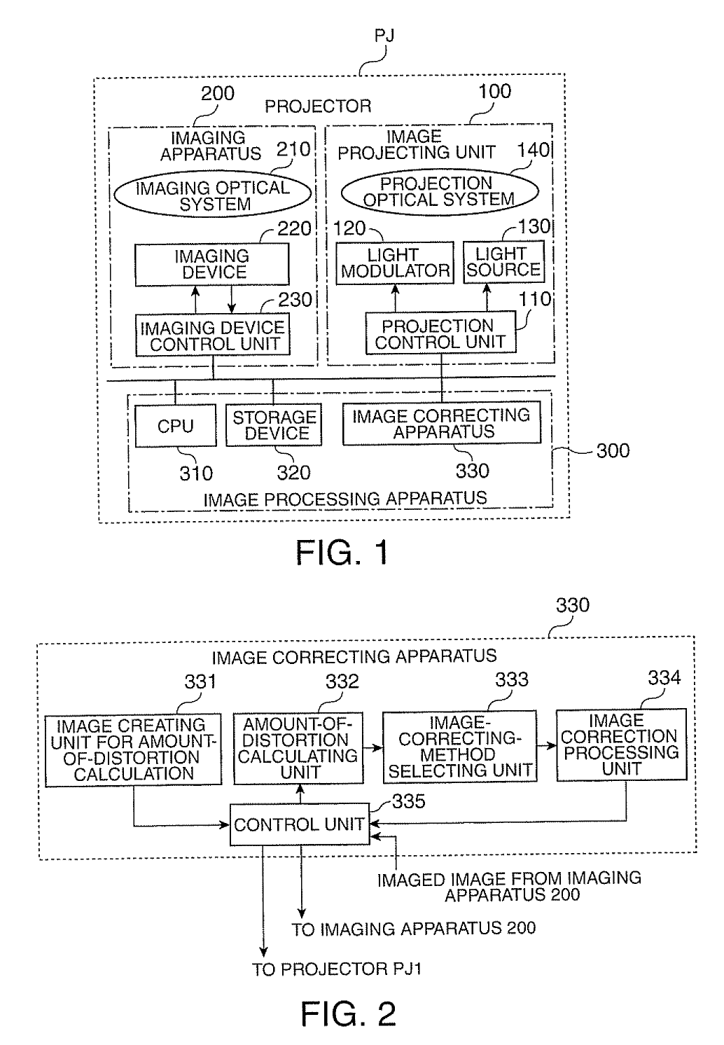

FIG. 1 is a diagram showing the configuration of a projector according to the first embodiment. The projector according to a first embodiment includes, as shown in FIG. 1, an image projecting unit 100, a capturing apparatus 200 and an image processing apparatus 300.

The image projecting unit 100 has a projection control unit 110, a light modulator 120 such as a liquid crystal panel, a light source 130, a projection optical system 140. The projection optical system emits the image light based on the image data image-processed by the image processing apparatus 300. Notably, the image projecting unit 100 further has other optical systems in addition to those components, but they are not shown because they are publicly known components that general projectors have.

The capturing apparatus 200 has a capturing optical system 210, a capturing device 220, and a capturing device control unit 230 that controls the capturing device 220, such as obtaining output signals from the capturing device 220. It is assumed here that the resolution of the capturing device 220 is higher than the resolution of the light modulator 120.

The image processing apparatus 300 has a CPU 310, a storage device 320 and an image correcting apparatus 330. The image correcting apparatus 330 performs image correction including correction on a projected image (such as correction of a trapezoidal distortion and correction on a distortion of the projected image caused by a local distortion of a screen, which is a projection plane). Notably, the processing for correcting the distortion of the projected image caused by the local distortion of the screen will be described later.

When a close projection system is configured by disposing the projector PJ shown in FIG. 1 at a position close to the screen, as illustrated in FIGS. 10A and 10B the projected image is distorted at the convex h under the influence of the local distortion on the screen SCR due to the local concave/convex (which is the convex h in FIG. 10B) on the screen SCR. According to the invention, the distortion of the projected image due to the local distortion of the screen SCR may be properly corrected.

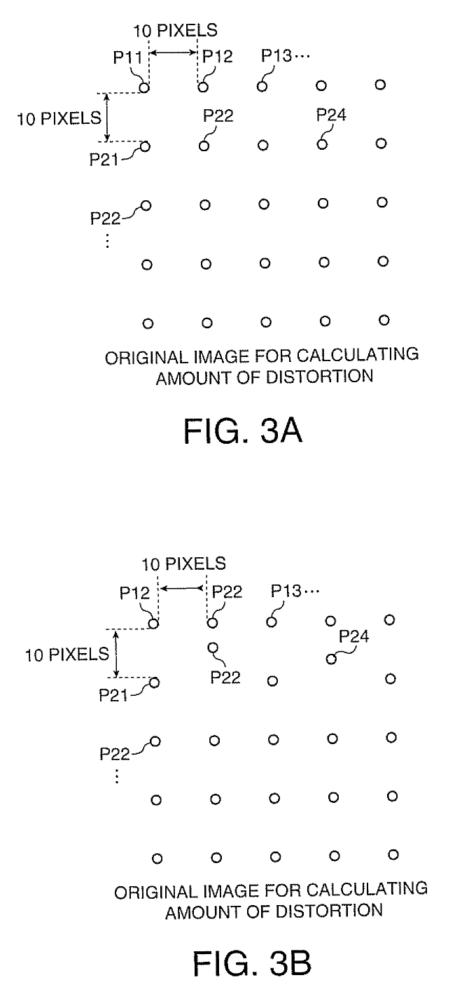

FIG. 2 is a diagram showing the configuration of the image correcting apparatus 330 shown in FIG. 1. The image correcting apparatus 330 has, as shown in FIG. 2, an image creating unit for amount-of-distortion calculation 331, an amount-of-distortion calculating unit 332, an image-correcting-method selecting unit 333, an image correction processing unit 334, and a control unit 335. The image creating unit for amount-of-distortion calculation 331 creates an image for calculating the amount of distortion (the detail of which will be described with reference to FIGS. 3A and 3B). The amount-of-distortion calculating unit 332 calculates the amount of distortion at each of the feature points (P11, P12, . . . and P21, P22, . . . in FIGS. 3A and 3B) on an image for calculating the amount of distortion on the basis of the captured image data (which will be called captured image) obtained by capturing the image for calculating the amount of distortion projected on a screen with the capturing apparatus 200. The image-correcting-method selecting unit 333 selects the image correcting method according to the calculated amount of distortion at each of the feature points. The image correction processing unit 334 performs image correction on the image to be projected by the projector PJ by using the selected image correcting method. The control unit 335 controls the capturing apparatus 200 and the projector PJ.

The image-correcting-method selecting unit 333 may have a function that determines the size of the amount of distortion at each of the feature points as one of a plurality of sizes of the amounts of distortion and a function that selects the image correcting method corresponding to the amount of distortion at the corresponding feature points from a plurality of kinds of image correcting methods having different accuracies of correction defined for the plurality of sizes.

Notably, in the projector PJ according to the first embodiment, the size of amount of distortion at each of the feature points is determined on the basis of the two sizes of amounts of distortion at the corresponding feature points including a size equal to or larger than a predetermined value (which is a threshold value TH1 for determining the amount of distortion) and a size smaller than the predetermined value, and it is assumed that the plurality of kinds of image correcting method having different accuracies of correction may be defined as two kinds of image correcting methods of a first image correcting method that allows highly accurate correction and a second image correcting method that performs correction with a lower accuracy than that of the first image correcting method.

If it is determined that the amount of distortion at one feature point among the feature points is equal to or higher than the threshold value TH1 for determining the amount of distortion, the first image correcting method may be selected for the feature point, and if it is determined that the amount of distortion at one feature point among the feature points is lower than the threshold value TH1 for determining the amount of distortion, the second image correcting method may be selected for the feature point. Notably, the first image correcting method may be an image correcting method by bicubic interpolation, and the second image correcting method may be an image correcting method by bilinear interpolation.

FIGS. 3A and 3B are diagrams showing examples of the image for calculating the amount of distortion to be projected to a screen and the captured image obtained by capturing the image for calculating the amount of distortion. It is assumed here that the image for calculating the amount of distortion is an image in which, as shown in FIG. 3A, the feature points P11, P12, . . . and P21, P22, . . . are arranged in the longitudinal direction and the lateral direction at equal intervals. Notably, the feature points P11, P12, . . . , and P21, P22, . . . will be simply called “feature points” without the reference numerals P11, P12, . . . , and P21, P22, . . . except for the cases where the individual feature points are to be described in the following description.

The feature points on the image for calculating the amount of distortion are defined correspondingly to the pixel at discrete positions among the pixels of the light modulator 120 (such as a liquid crystal panel) in the projector PJ. More specifically, each of the amounts of distortion calculation positions is defined so as to correspond to one pixel after every predetermined number of pixels in the pixels in the longitudinal direction and lateral direction of the light modulator. The image for calculating the amount of distortion shown in FIG. 3A is an example in which the feature points are defined at intervals each of which is equal to 10 pixels in the longitudinal direction and lateral direction of the light modulator.

FIG. 3B shows an image for calculating the amount of distortion obtained by projecting an image for calculating the amount of distortion (which will be called original image for calculating the amount of distortion) onto a screen (which will be called projected image for calculating the amount of distortion). The projected image for calculating the amount of distortion shown in FIG. 3B has a “displacement” of the positions of feature points (such as the feature point P22 and P24) corresponding to the local distortion of the screen from the original image for calculating the amount of distortion shown in FIG. 3A.

Capturing the projected image for calculating the amount of distortion with the capturing apparatus 200 naturally results in the captured image on which the feature points corresponding to the local distortion of the screen have “displacements” from those in the original image for calculating the amount of distortion shown in FIG. 3A. For example, when a screen has a local distortion as shown in FIG. 10B, the captured image has “displacements”0 of the feature points in accordance with the amount of distortion of the local distortion at the part corresponding to the local distortion of the screen from those of the original image for calculating the amount of distortion.

Each of the “displacements” is determined by comparing the amounts of distortion of a local distortion of the screen. Therefore, by calculating the “displacement” of the respectively corresponding feature points between the captured image output from the capturing apparatus 200 and the original image for calculating the amount of distortion, the amount of distortion of the local distortion of the screen can be obtained. Notably, according to this embodiment of the invention, the amount of distortion of the local distortion of the screen is expressed by the amount of distortion at the corresponding feature point on an image for calculating the amount of distortion.

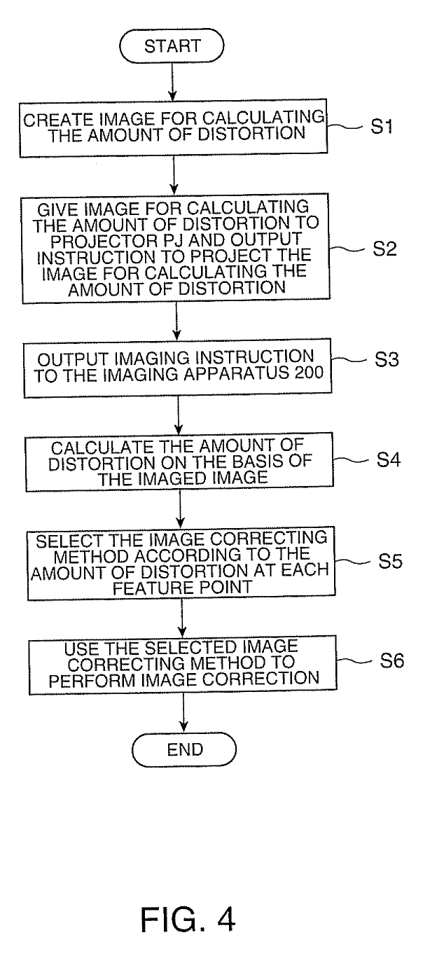

FIG. 4 is a flowchart illustrating the entire processing routine to be performed by the image correcting apparatus 330. First of all, the image creating unit for amount-of-distortion calculation 331 creates an image for calculating the amount of distortion (step S1). The control unit 335 gives the created image for calculating the amount of distortion to the image projecting unit 100 and outputs an instruction to project the image for calculating the amount of distortion to the image projecting unit 100 (step S2). Thus, the image projecting unit 100 projects the image for calculating the amount of distortion to a screen.

The control unit 335 further outputs an capturing instruction to image the image for calculating the amount of distortion projected on the screen to the capturing apparatus 200 (step S3). Thus, the capturing apparatus 200 images the image for calculating the amount of distortion projected on the screen. Then, the captured image output from the capturing apparatus 200 is received by the amount-of-distortion calculating unit 332 through the control unit 335, and the amount of distortion at each feature point on the image for calculating the amount of distortion is calculated (step S4).

Then, the image-correcting-method selecting unit 333 selects the image correcting method according to the amount of distortion at each feature point (step S5). Next, the image correction processing unit 334 uses the image correcting method selected by the image-correcting-method selecting unit 333 to perform local image correction on the image to be projected (step S6).

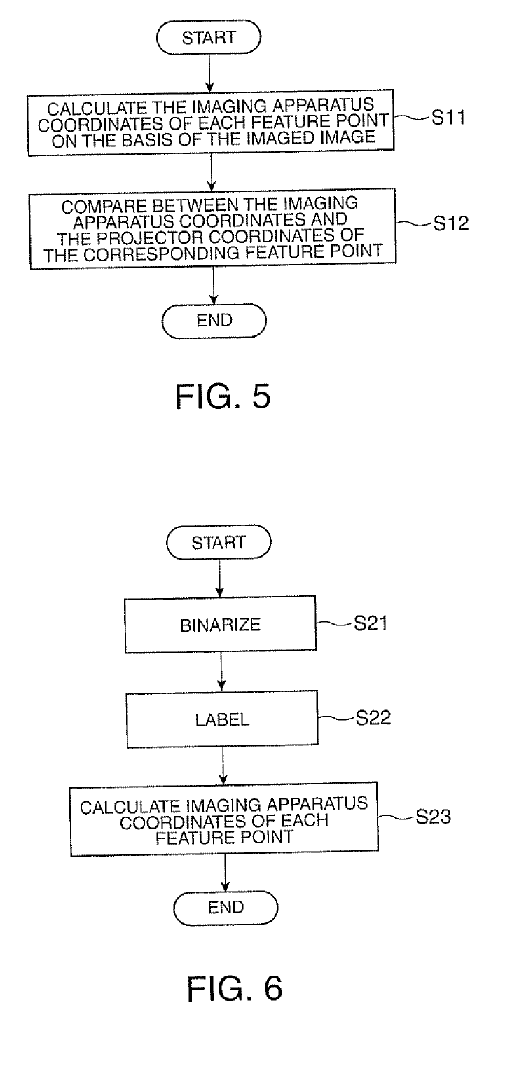

FIG. 5 is a flowchart illustrating a processing routine for calculating the amount of distortion at each feature point. As shown in FIG. 5, the amount of distortion at each feature point on the image for calculating the amount of distortion is obtained by first calculating the coordinates of each feature point on the captured image (which will be called capturing apparatus coordinates) on the basis of the captured image obtained by capturing the projected image for calculating the amount of distortion (refer to FIG. 3A) (step S11) and comparing between the calculated capturing apparatus coordinates of each feature point and the coordinates at the corresponding feature point of the original image for calculating the amount of distortion (refer to FIG. 3A) (which will be called projector coordinates) (step S12).

If the screen does not have a local distortion here, the capturing apparatus coordinates and the projector coordinates agree at the respectively corresponding feature points. If the screen has a local distortion, “displacements” occur between the capturing apparatus coordinates and the projector coordinates at the respectively corresponding feature points in the part corresponding to the local distortion. Notably, as the amount of distortion of local distortion of the screen increases, the amount of the “displacement” at the corresponding feature points increases.

FIG. 6 is a flowchart illustrating the processing for calculating the capturing apparatus coordinates of each feature point in step S11 in FIG. 5. The processing for calculating the capturing apparatus coordinates of each feature point includes, as shown in FIG. 6, binarizing captured image (step S21), labeling the binarized captured image (step S22), and calculating the capturing apparatus coordinates of the feature point from the labeling result (step S23).

Here, the binarization of an captured image in step S21 includes defining a threshold value TH2 (such as the middle value between the maximum value and the minimum value of the pixel values of an captured image) for pixel values and binarizing on the basis of the determination on whether the pixel value of the corresponding pixel is equal to or higher than the threshold value TH2 (which will be called binarization threshold value TH2) or not. For example, it is assumed that ‘1’ is given to the pixel having the pixel value equal to or higher than the binarization threshold value TH2, and ‘0’ is given to the pixel having the pixel value lower than the binarization threshold value TH2.

The labeling processing in step S22 includes labeling the area having a series of ‘1’ as a result of the binarized result, where the area having a series of ‘1’ is a set of pixels corresponding to the subject feature points.

The processing for calculating the capturing apparatus coordinates of each feature point in step S23 assumes that, if binarized image data is used, the position of the pixel at the barycenter of the labeled area is the coordinates position of the feature point. It further assumes that, if the image data before the binarization is used, the position of the pixel having the maximum pixel value in the labeled area is the coordinates position of the feature point.

If the coordinates position of the feature point is calculated from the captured image, the calculated capturing apparatus coordinates of each feature point and the projector coordinates of the feature point on the original image for calculating the amount of distortion are compared (step S12 in FIG. 5). The comparison between the capturing apparatus coordinates of each feature point and the projector coordinates of each feature point can be performed by using the least squares method, for example.

If the screen does not have a local distortion here, the capturing apparatus coordinates and projector coordinates of the corresponding feature points agree. On the other hand, if the screen has a local distortion, a “displacement” occurs at the local distortion part between the capturing apparatus coordinates and projector coordinates of the corresponding feature points. Therefore, the comparison between the capturing apparatus coordinates of each feature point and the projector coordinates of the corresponding feature point can result in the calculation of the amount of distortion at the feature point on the image for calculating the amount of distortion.

Notably, the amount of distortion at each feature point on the calculated image for calculating the amount of distortion corresponds to the local distortion of the screen. Therefore, the amount of distortion at each feature point of the calculated image for calculating the amount of distortion reflects the amount of distortion of the local distortion of the screen.

If the amount of distortion at the feature point on the image for calculating the amount of distortion is obtained in this way, the image-correcting-method selecting unit 333 selects the image correcting method according to the amount of distortion at the feature point. More specifically, the image-correcting-method selecting unit 333 determines whether the amount of distortion at the feature point is equal to or higher than the threshold value TH1 for determining the amount of distortion or not. If so, the image correcting method by bicubic interpolation is selected for the feature point. If not, the image correcting method by bilinear interpolation is selected for the feature point.

Then, the image correction processing unit 334 performs image correction by using the image correcting method selected by the image-correcting-method selecting unit 333. Notably, it is assumed that the subject pixel of the image correction is positioned within a local area including the feature point (which will be called feature point to be corrected) having a predetermined “displacement” between the capturing apparatus coordinates and the projector coordinates.

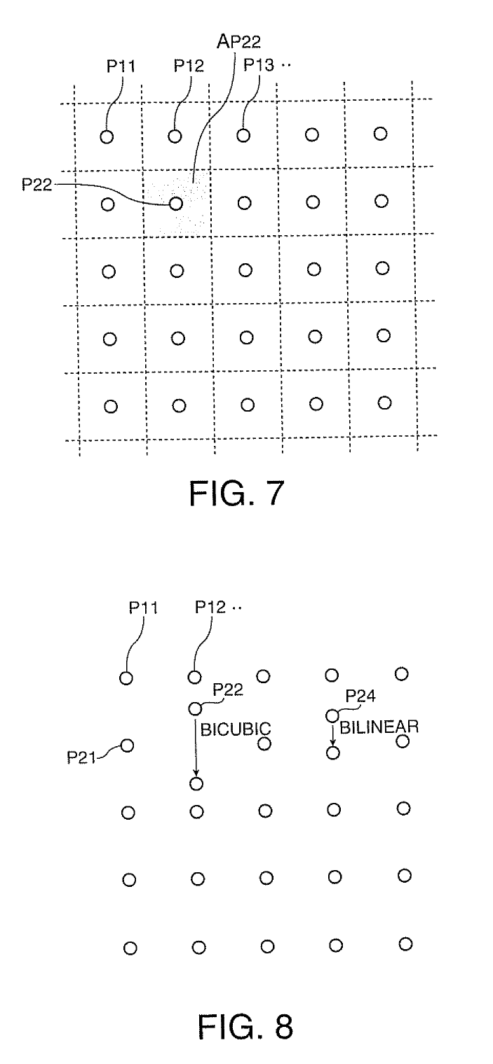

FIG. 7 is a diagram illustrating a definition example of the subject local area of the correction. It is assumed that the subject local area for the correction is a rectangular area (which is the area enclosed by broken lines) about each feature point, as shown in FIG. 7, on the image for calculating the amount of distortion (which is the same as the image for calculating the amount of distortion shown in FIG. 3A). The pixel within the local area is handled as the pixel to be corrected. For example, if the feature point P22 is the feature point to be corrected, the local area Aₚ₂₂ (which is the shaded area) including the feature point P22 is defined, and the pixel present in the local area Aₚ₂₂ is defined as the pixel to be corrected on the image to be projected.

Notably, the local area including each feature point to be defined is an extremely narrower area than the area of the entire projected image. While FIG. 7 shows the example in which adjacent local areas are defined not to overlap with each other, some pixels may be defined to overlap with each other. Conversely, neighboring local areas do not have to border with each other, and some space may be provided between the pixels.

In the example in FIGS. 3A and 3B, the projector coordinates and the capturing apparatus coordinates of the feature point P22 and feature point P24 have “displacements”. If, as a result of the comparison between the projector coordinates and capturing apparatus coordinates of the feature point P22, the calculated amount of distortion (which will be called Wₚ₂₂) at the feature point P22 is equal to or higher than the threshold value TH1 for determining the amount of distortion (Wₚ₂₂≧TH1), the image-correcting-method selecting unit 333 selects the image correcting method by bicubic interpolation. Thus, the image correction processing unit 334 performs image correction by bicubic interpolation on the pixel within the local area Aₚ₂₂ including the feature point P22.

In the same manner, if, as a result of the comparison between the projector coordinates and capturing apparatus coordinates of the feature point P24, the calculated amount of distortion Wₚ₂₄ at the feature point P24 is lower than the threshold value TH1 for determining the amount of distortion (Wₚ₂₄<TH1), the image-correcting-method selecting unit 333 selects the image correcting method by bilinear interpolation. Thus, the image correction processing unit 334 performs image correction by bilinear interpolation on the pixel within the local area Aₚ₂₄ including the feature point P24.

FIG. 8 is a diagram illustrating an example of the image correction by the selected image correcting method. FIG. 8 shows an image correction result on the captured image shown in FIG. 3B. In the example, the feature point P22 at the position shown in FIG. 3B undergoes the image correction by bicubic interpolation while the feature point P24 at the position shown in FIG. 3B undergoes the image correction by bilinear interpolation.

As a result of the image correction on the image to be projected, the projection of the image-corrected image by the projector can prevent the occurrence of the influence by the distortion of the screen SCR on the projected image on the screen SCR in FIGS. 10A and 10B when viewed from the direction of line of sight, for example.

As described above, according to the embodiment of the invention, the distortion of the projected image caused by a local distortion of the screen is corrected by calculating the amount of distortion of the local distortion of the screen as the amount of distortion at each feature point on the image for calculating the amount of distortion and using the image correcting method according to the calculated amount of distortion at each feature point for the image correction. In other words, if the amount of distortion at one feature point is equal to or higher than the threshold value TH1 for determining the amount of distortion, the image correction by bicubic interpolation, which allows correction with higher accuracy, is performed on the local area (which is the area corresponding to the area in a predetermined range including the feature point) on the image to be projected. If the amount of distortion at one feature point is lower than the threshold value TH1 for determining the amount of distortion, the image correction by bilinear interpolation is performed on the local area (which is the area corresponding to the area in a predetermined range including the feature point) on the image to be projected.

This allows the image correction according to the amount of distortion of the local distortion of the screen on the image to be projected. Therefore, by projecting the thus corrected image onto a screen with a projector, the entire projected image on the screen can have aesthetically even sharpness. In other words, when a screen has plural local distortions having different amounts of distortion and if one same correcting method is used to perform image correction on the entire projected image, a problem may possibly occur that the sharpness of the entire projected image after the correction may not be even, resulting in an image having locally different MTFs. According to the invention, the problem can be prevented.

### Second Embodiment

While, according to the first embodiment, the image correcting apparatus 330 is built in the projector PJ, the image correcting apparatus 330 may be provided as a separate component from a projector PJ, and a projection system may be configured by the projector PJ and the image correcting apparatus 330.

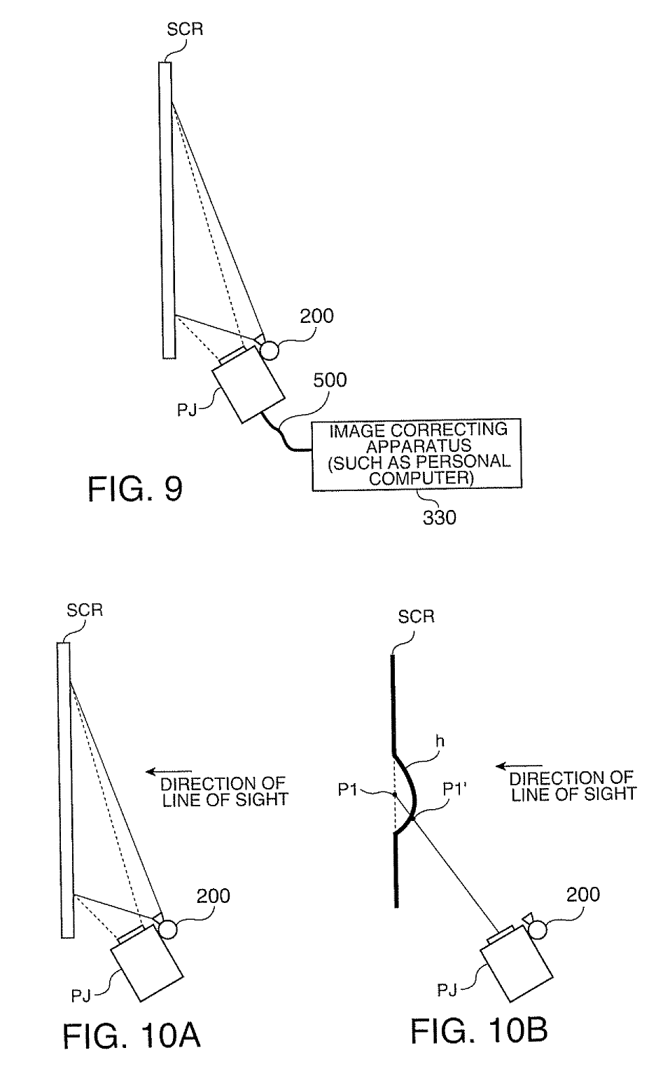

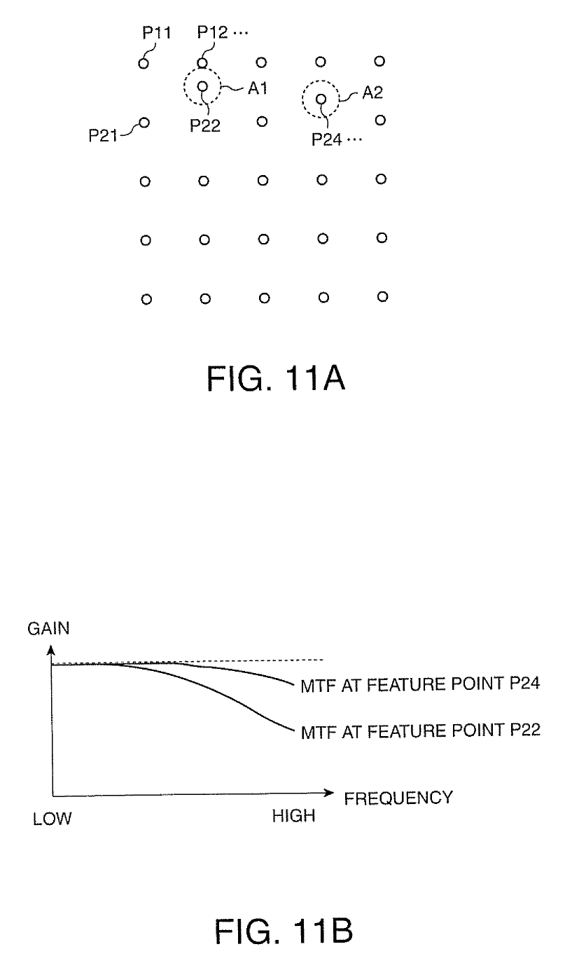

FIG. 9 is a diagram showing the configuration of a projection system according to the second embodiment. The projection system according to the second embodiment is a close projection system in which the projector PJ is disposed closely to a screen SCR. The projection system according to the second embodiment includes, as shown in FIG. 9, the projector PJ, an capturing apparatus 200, the image correcting apparatus 330, and a connection cable 500.

The image correcting apparatus 330 may be implemented by an information processing apparatus (such as a personal computer) having the function. The image correcting apparatus 330 has an image creating unit for amount-of-distortion calculation 331, an amount-of-distortion calculating unit 332, a correcting method selecting unit 333, an image correction processing unit 334 and a control unit 335 (refer to FIG. 2). Notably, because the processing to be performed by the image correcting apparatus 330 has been described in the description on the projector PJ according to the first embodiment, the description will be omitted below.

In the example shown in FIG. 9, the image correcting apparatus 330 has components including the image creating unit for amount-of-distortion calculation 331, amount-of-distortion calculating unit 332, image-correcting-method selecting unit 333, image correction processing unit 334, control unit 335, which are provided separately from the projector PJ. However, a part of the components may be provided in the projector PJ.

Notably, the invention is not limited to the embodiments, but variation embodiments may be implemented without departing from the spirit and scope of the invention as described in:

1. Though, according to the embodiments, one of two kinds of image correcting method is selected on the basis of the determination on whether the amount of distortion at each feature point is equal to or higher than a predetermined value (or threshold value TH1 for determining the amount of distortion), the invention is not limited thereto. For example, two threshold values may be defined for determining the size of amount of distortion at each feature point, and the size of amount of distortion may be determined as one of the three sizes.

In this case, image correcting methods with different accuracies of correction may be defined for the sizes. Then, which one of the plural sizes the amount of distortion at a subject feature point belongs to is determined, and the image correcting method is selected on the basis of the determination result. Then, the selected image correcting method is used to perform the image correction. Notably, the image correcting methods for the sizes are defined such that, as the amount of distortion at a subject feature point increases, the accuracy of the image correction can increase. Because, in this way, the size of amount of distortion at each feature point is determined as one of the plural sizes of amount of distortion, and the image correction method suitable for the determined amount of distortion is selected to perform the image correction, appropriate image correction can be performed in accordance with the size of amount of distortion at each feature point.

2. While the capturing apparatus 200 is integrated to the projector PJ, for example (refer to FIG. 9), the capturing apparatus 200 may be provided as a separate component from the projector PJ and may be disposed at a separate position from the projector PJ.

3. Though, according to the embodiments, the image correcting apparatus 330 has the image creating unit for amount-of-distortion calculation 331 and the image creating unit for amount-of-distortion calculation 331 creates an image for calculating the amount of distortion, the invention is not limited thereto. An image for calculating the amount of distortion corresponding to the image for calculating the amount of distortion may be prestored in a storage device, and the image for calculating the amount of distortion may be loaded from the storage device as required and be projected by the projector PJ.

4. Though, the image for calculating the amount of distortion applied by the embodiment has the feature points as the amount-of-distortion calculation positions in the longitudinal direction and lateral direction at equal intervals, the invention is not limited thereto. The feature points may be only required to be identifiable on an captured image. For example, the feature points may be provided on lines in the longitudinal direction and lateral direction at equal intervals in a grid pattern. In this case, the positions (having the grid points) where the lines in the longitudinal direction and lateral direction intersect may be defined as the feature points. The calculation of the amount of distortion may be performed at each of the feature points.

5. Though, according to the embodiments, the image correcting methods may apply bicubic interpolation or bilinear interpolation, the image correcting method is not limited thereto. Other image correcting methods may be applied.

The entire disclosure of Japanese Patent Application No. 2008-186836, filed Jul. 18, 2008 is expressly incorporated by reference herein.

What is claimed is:

1. An image correcting apparatus that corrects an image to be projected by a projector on the basis of a local distortion of a projection planer the apparatus comprising:
an amount-of-distortion calculating unit that calculates the amount of distortion at each of a plurality of feature points on an image, which is projected on the projection plane, for calculating the amount of distortion on the basis of the captured image obtained by capturing the image;
an image-correcting-method selecting unit that selects an image correcting method according to the amount of distortion at each of the feature points, which is calculated by the amount-of-distortion calculating unit; and
an image correction processing unit that corrects a predetermined area of the image to be projected by the image correcting method selected by the image-correcting-method selecting unit.

2. The image correcting apparatus according to claim 1, wherein the feature points are defined in connection with a plurality of pixels at discrete positions among the pixels in a light modulator in the projector.

3. The image correcting apparatus according to claim 1, wherein the amount-of-distortion calculating unit calculates each of the amounts of distortion at the feature points on the basis of the coordinates of the feature point on the image for calculating the amount of distortion and the coordinates of the feature point on the captured image obtained by capturing the image for calculating the amount of distortion.

4. The image correcting apparatus according to claim 1, wherein
the image-correcting-method selecting unit has a function that determines the size of the amount of distortion at each of the feature points and a function that selects the image correcting method corresponding to the amount of distortion at the corresponding feature point from a plurality of kinds of image correcting methods having different accuracies of correction defined for the size of the amount of distortion.

5. The image correcting apparatus according to claim 4, wherein
the plurality of sizes are two sizes of amounts of distortion at the feature points including a size equal to or larger than a predetermined value and a size smaller than the predetermined value, the plurality of kinds of image correcting method having different accuracies of correction are two kinds of image correcting methods of a first image correcting method that allows highly accurate correction and a second image correcting method that performs correction with a lower accuracy than that of the first image correcting method; and
if it is determined that the amount of distortion at one feature point among the feature points is equal to or higher than the predetermined value, the first image correcting method is selected for the feature point, and if it is determined that the amount of distortion at one feature point among the feature points is lower than the predetermined value, the second image correcting method is selected for the feature point.

6. The image correcting apparatus according to claim 5, wherein
the first image correcting method is an image correcting method by bicubic interpolation, and the second image correcting method is an image correcting method by bilinear interpolation.

7. The image correcting apparatus according to claim 1, wherein
a predetermined area, which is to be corrected by the image correction processing, of the image to be projected is a local area including the pixel, which corresponds to the feature point, of the image to be projected.

8. The image correcting apparatus according to claim 1, wherein
the projector is disposed at a position close to the projection plane and is disposed such that the projected light can launch into the projection plane at an acute angle.

9. An image correcting method that corrects an image to be projected by a projector on the basis of a local distortion of the projection plane, the method comprising:
calculating the amount of distortion at each of a plurality of feature points on an image, which is projected on the projection plane, for calculating the amount of distortion on the basis of the captured image obtained by capturing the image;
selecting an image correcting method according to the calculated amount of distortion at each of the feature points; and
correcting a predetermined area of the image to be projected by the selected image correcting method.

10. A projector comprising an image correcting apparatus that corrects an image to be projected on the basis of a local distortion of the projection plane, the image correcting apparatus having:
an amount-of-distortion calculating unit that calculates the amount of distortion at each of a plurality of feature points on an image, which is projected on the projection plane, for calculating the amount of distortion on the basis of the captured image obtained by capturing the image;
an image-correcting-method selecting unit that selects an image correcting method according to the amount of distortion at each of the feature points, which is calculated by the amount-of-distortion calculating unit; and
an image correction processing unit that corrects a predetermined area of the image to be projected by the image correcting method selected by the image-correcting-method selecting unit.

11. A projection system comprising a projector that projects an image to a projection plane and an image correcting apparatus that corrects the image to be projected by the projector on the basis of a local distortion of the projection plane, the image correcting apparatus having:
an amount-of-distortion calculating unit that calculates the amount of distortion at each of a plurality of feature points on an image, which is projected on the projection plane, for calculating the amount of distortion on the basis of the captured image obtained by capturing the image;
an image-correcting-method selecting unit that selects an image correcting method according to the amount of distortion at each of the feature points, which is calculated by the amount-of-distortion calculating unit; and
an image correction processing unit that corrects a predetermined area of the image to be projected by the image correcting method selected by the image-correcting-method selecting unit.
